(19) United States
(12) Patent Application Publication
(10) Pub. No.: US 2012/0312941 A1
(43) Pub. Date: Dec. 13, 2012

(54) MOUNTING SYSTEM AND METHOD FOR MOUNTING A CURVED PANEL TO A FRAME

(76) Inventors: Glenn A. Reynolds, Long Beach, CA (US); Dean R. Hackbarth, Las Vegas, NV (US)

(21) Appl. No.: 13/491,422

(22) Filed: Jun. 7, 2012

Related U.S. Application Data
(60) Provisional application No. 61/494,209, filed on Jun. 7, 2011.

(51) Int. Cl. F16M 13/02; B23P 17/04

(52) U.S. Cl. 248/201; 29/428

(57) ABSTRACT

Embodiments of to a mounting system and method for mounting curved panel to a frame are generally described herein. Other embodiments may be described and claimed.

### CROSS-REFERENCE TO RELATED APPLICATION

The present application claims the benefit of the filing date of U.S. Provisional Patent Application Ser. No. 61/494,209, filed on Jun. 7, 2011, the entire disclosure of which is expressly incorporated by reference herein.

### FIELD

This disclosure generally relates to mounting systems and methods, and more particularly, to a mounting system and method for mounting curved panel to a frame.

### BACKGROUND

Reflective solar power generation systems may either use a number of spaced apart reflective panels that surround a central tower and reflect sunlight toward the central tower or parabolic-shaped reflective panels that focus sunlight onto a tube at the focal point of the parabola defining the reflective panels. In both systems, the reflective panels may be attached to a supporting frame. In both systems, a large number of reflective panels may have to be attached to corresponding frames during on-site installation of the system. Accordingly, a large installation crew and long installation times may be necessary to attach each reflective panel to a corresponding frame. The attachment of each panel to a corresponding frame may require several individuals lifting and placing a reflective panel to a frame, while the same individuals or other individuals securely attach a backing structure of the panel to individual frame members with fasteners. Repeating the noted installation process for each panel may require a long installation period and a large installation crew for a large field installation. Furthermore, replacement of one or more panels when necessary during operation of the system may also require long maintenance periods and large maintenance crew. Thus, reducing the number of individuals and the time period required to install a reflective panel to corresponding frame and replace any damaged panels during operation of the system can significantly reduce installation and operational costs.

### SUMMARY

According to one embodiment, a system for mounting a curved panel to a frame includes a plurality of first mating assemblies, each first mating assembly having a first side defining a first mating portion and a second side configured to attach to the curved panel and being spaced apart from an adjacent first mating assembly along a curvature of the panel when attached to the curved panel. The system further includes a plurality of second mating assemblies, each second mating assembly having a first side defining a second mating portion and a second side configured to attach to the frame and being spaced apart from an adjacent second mating assembly along the frame when the second mating assembly is attached to the frame, each of the second mating portions configured to removably mate with one of the first mating portions to connect the plurality of first mating assemblies to the plurality of second mating assemblies. The second mating portion of each of the second mating assemblies is configured generally along the curvature of the panel relative to the second mating portion of an adjacent second mating assembly.

According to another embodiment, a method of mounting a curved panel to a frame includes attaching a plurality of first mating assemblies to the curved panel such that each of the first mating assemblies is spaced apart from an adjacent first mating assembly along a curvature of the panel, each first mating assembly having a first side defining a first mating portion and a second side configured to attach to the curved panel. The method further includes attaching a plurality of second mating assemblies to the frame such that each of the second mating assemblies is spaced apart from an adjacent second mating assembly along the frame, each second mating assembly having a first side defining a second mating portion and a second side configured to attach to the frame, and the second mating portion of each of the second mating assemblies configured generally along the curvature of the panel relative to the second mating portion of an adjacent second mating assembly. The method further includes removably mating each of the first mating portions with one of the second mating portions to connect each of the first mating assemblies to a corresponding one of the second mating assemblies.

According to another embodiment, a system for mounting a curved panel to a frame includes a plurality of first mating assemblies configured to attach to the curved panel, and a plurality of second mating assemblies configured to attach to the frame. Each of the first mating assemblies is spaced apart from an adjacent mating assembly along a curvature of the panel when the first mating assemblies are attached to the curved panel. Each of the first mating assemblies includes a longitudinal member extending along a length of the curved panel when the first mating assembly is attached to the curved panel, and a generally U-shaped first channel attached to the longitudinal member. Each of the second mating assemblies includes an offset section configured to attach to the frame in a spaced apart configuration relative to the offset section of an adjacent second mating assembly, and a generally U-shaped second channel attached to the offset section. The offset section is configured to provide an offset distance for the generally U-shaped second channel relative to the frame such that the generally U-shaped second channel is positioned generally along the curvature of the panel relative to generally U-shaped second channel of an adjacent second mating assembly. A portion of the generally U-shaped first channel is located inside the generally U-shaped second channel and a portion of the generally U-shaped second channel is located inside the generally U-shaped first channel when the first mating assembly and the second mating assembly are removable connected.

### BRIEF DESCRIPTION OF THE DRAWINGS

FIG. 1 shows a perspective view of a frame for mounting one or more solar reflective panels according to one embodiment.

FIG. 2 shows a perspective view of a node of the frame of FIG. 1.

FIG. 3 shows a front view of a section of the frame of FIG. 1.

FIG. 4 shows a perspective view of a reflector mount assembly according to one embodiment.

FIG. 5 shows a perspective view of another reflector mount assembly according to one embodiment.

FIG. 6 shows a perspective view of another reflector mount assembly according to one embodiment.

FIG. 7 shows a perspective view of another reflector mount assembly according to one embodiment.

FIG. 8 shows another perspective view of the reflector mount assembly of FIG. 7.

FIG. 9 shows a cross-sectional view of a stringer offset of the reflector mount assembly of FIG. 4.

FIG. 10 shows a cross-sectional view of a stringer offset of the reflector mount assembly of FIG. 5.

FIG. 11 shows a cross-sectional view of a stringer offset of the reflector mount assembly of FIG. 6.

FIG. 12 shows a cross-sectional view of a stringer offset of the reflector mount assembly of FIGS. 7 and 8.

FIG. 13 is an enlarged view of section 13 of FIG. 10.

FIG. 14 shows a partial cross-sectional view of a reflector mount member prior to being connected to a reflector stringer.

FIG. 15 shows a partial cross-sectional view of a reflector mount member after being connected to a reflector stringer.

FIG. 16 shows a partial cross-sectional view of a reflector mount member being fastened to a reflector stringer according to the embodiment of FIGS. 7 and 8.

FIGS. 17-20 show partial cross-sectional views of a reflector mount member according to another embodiment.

### DETAILED DESCRIPTION

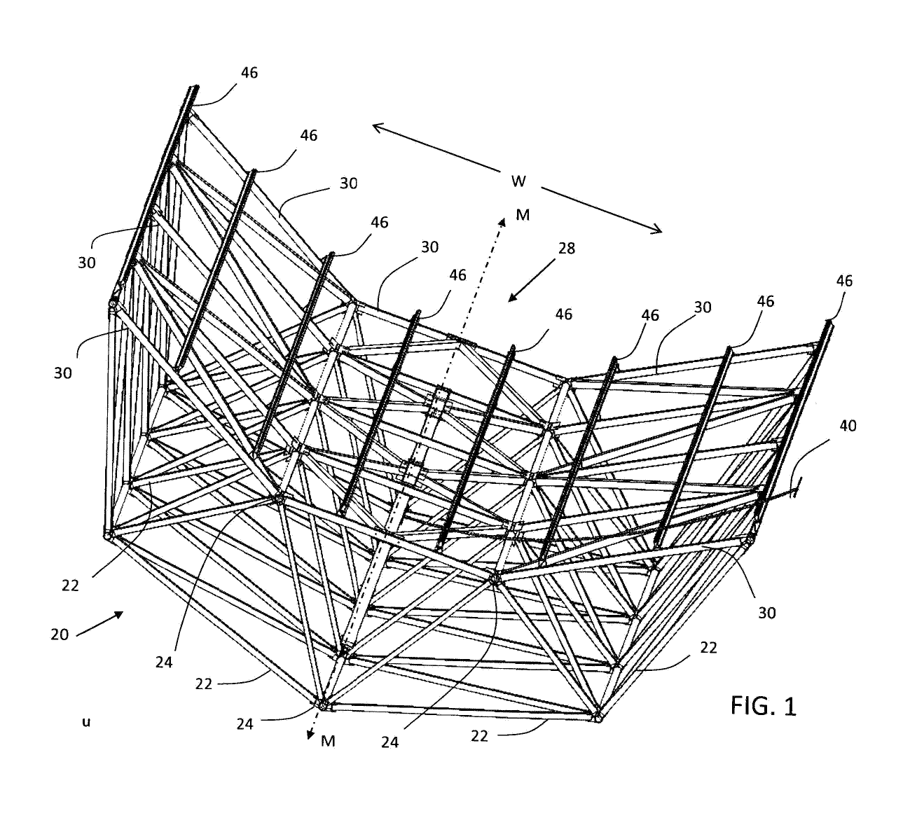

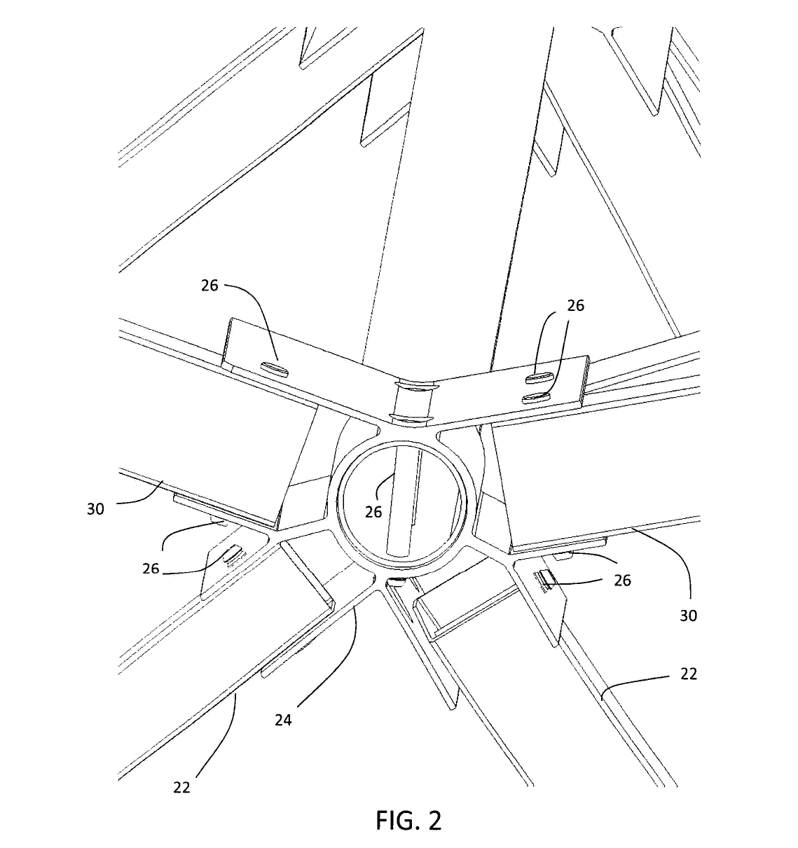

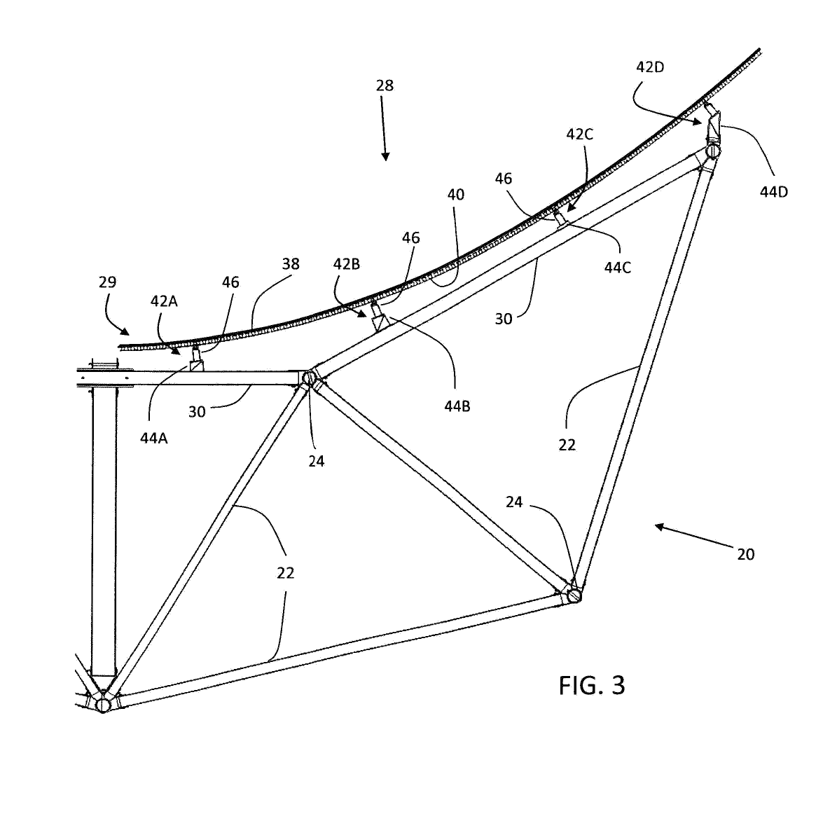

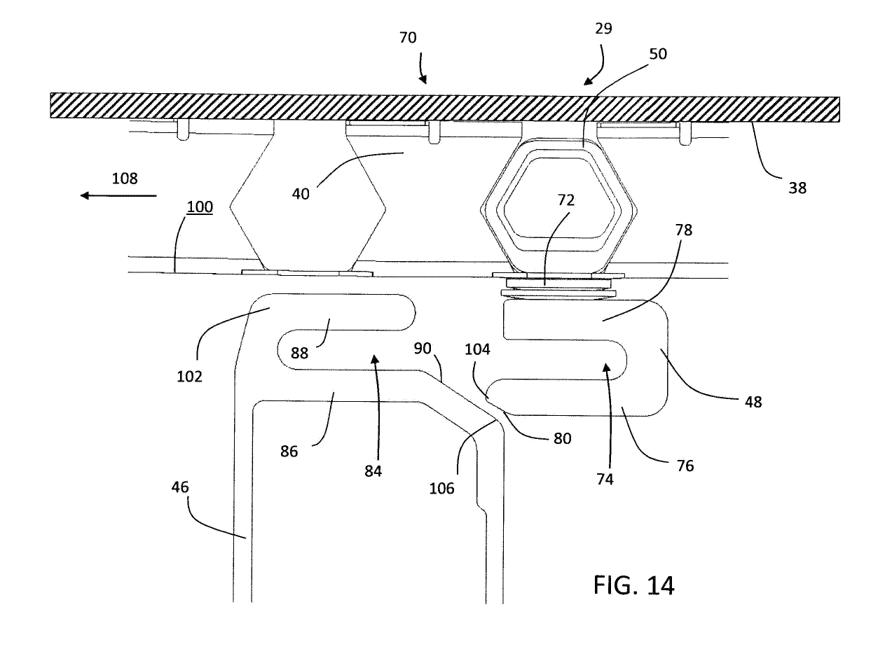

Referring to FIGS. 1-3, a space frame 20 (hereinafter referred to as frame 20) according to an exemplary embodiment is shown. The frame 20 includes a plurality of frame members 22 which are interconnected at nodes 24 with pins 26 and/or other types of fastening devices and methods. Details of the space frame 20 are provided in U.S. Pat. Nos. 7,587,862; 7,578,109; and 7,530,201, all of which are entirely incorporated by reference herein. The frame 20 includes a plurality of frame members 22 that define a trough-shaped solar collector side 28 to accommodate one or more reflector assemblies 29 (shown only in FIGS. 3 and 14). Each reflector assembly may be in the form of a curved panel, such as a parabolic shaped panel. Each of the frame members 22 on the collector side 28 may be referred to herein as a collector side frame member 30. The reflector assemblies 29 may include a reflector 38 (shown only in FIGS. 3 and 14) and a backing structure 40, which is shown in the exemplary embodiments presented herein as a mini-truss thin sheet panel. The reflector 38 may be constructed with any type of material that can provide a light reflective surface. For example, the reflector 38 may be a minor. Details of the mini-truss thin sheet panel and assembly thereof with a reflector are provided in detail in U.S. Pat. No. 8,132,391 and U.S. Pat. Application Pub. 2009/0101195, both of which are entirely incorporated by reference herein.

The frame 20 may be symmetrical about a center axis M as shown in FIG. 1 and accommodate a reflector assembly 29 on each side of the center axis M. Accordingly, only one side of the frame 20 and one reflector assembly 29 is described in the following for sake of brevity. The backing structure 40 shown in the drawings generally represents the parabolic cross-sectional shape of the reflector assembly 29. The frame 20 may have any preferred length along a longitudinal axis of the frame, which in this example is the same as the center axis M, and any preferred width along a lateral axis W. The reflector assembly extends longitudinally along the axis M. The reflector assembly may also extend in width along the axis W from at or near the center axis M to the outer edge of the frame 20 or may extend beyond the outer edge of the frame 20 as shown in FIGS. 1 and 3.

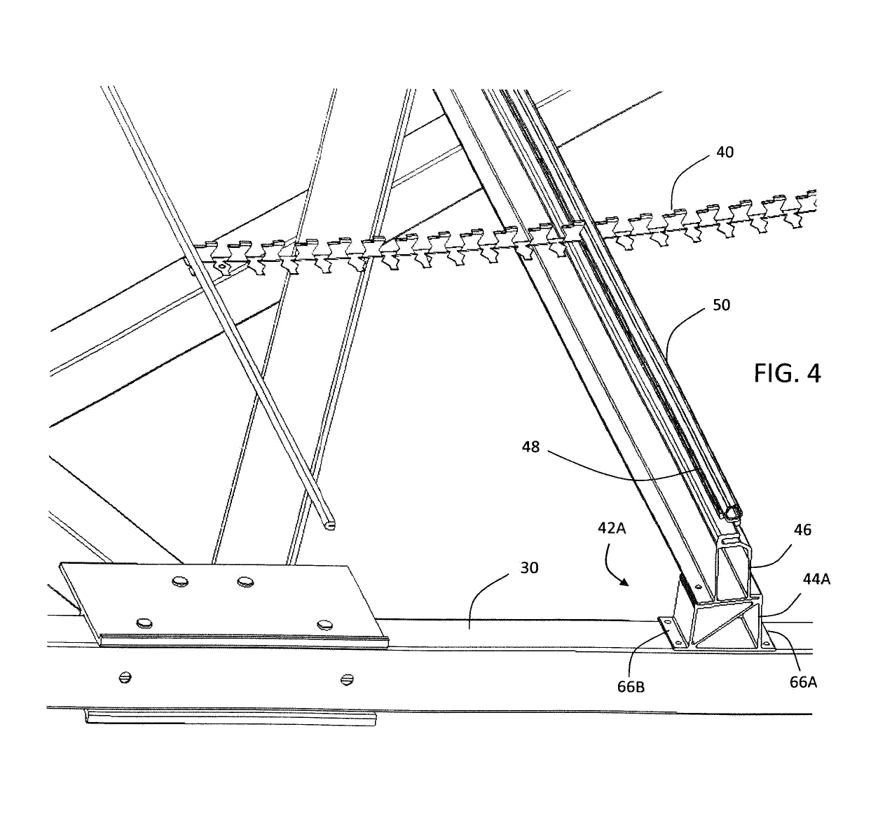

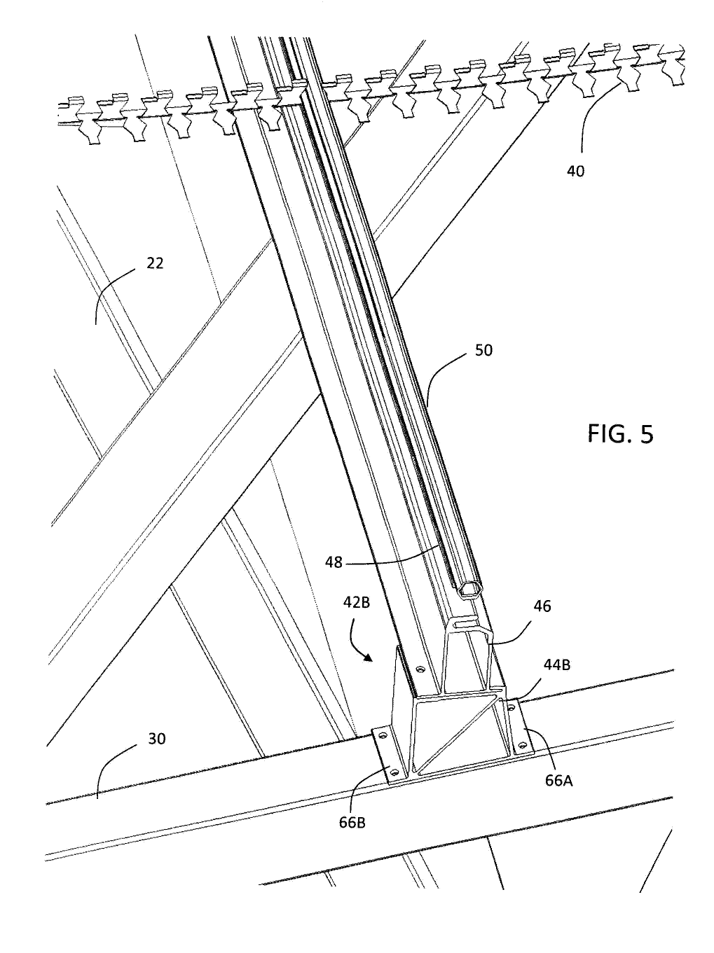

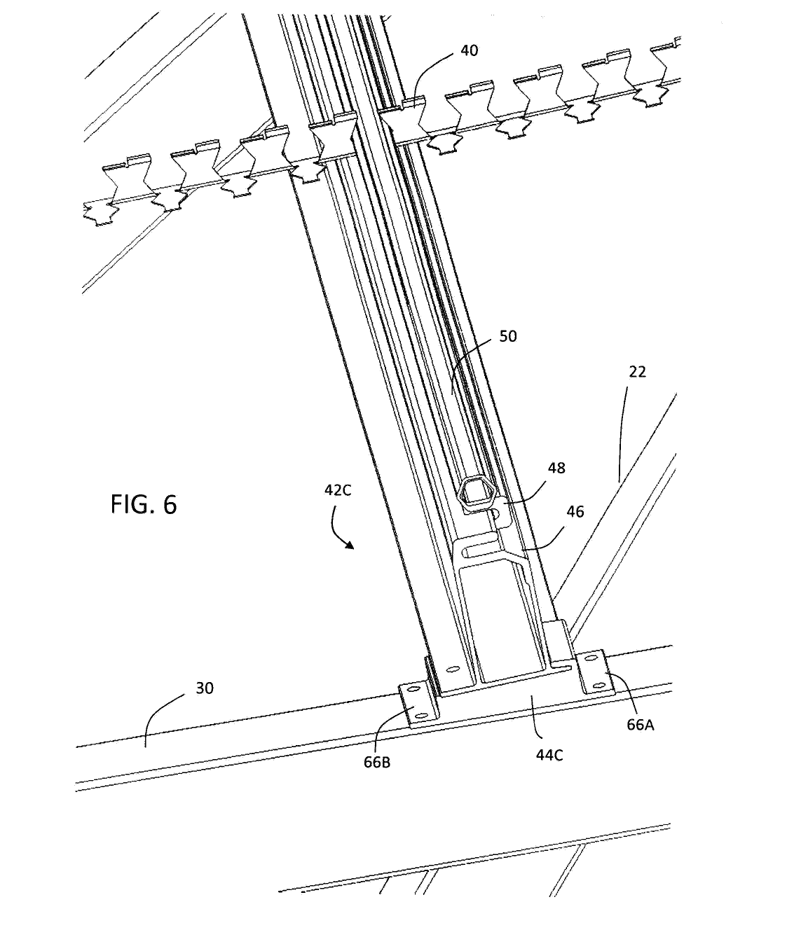

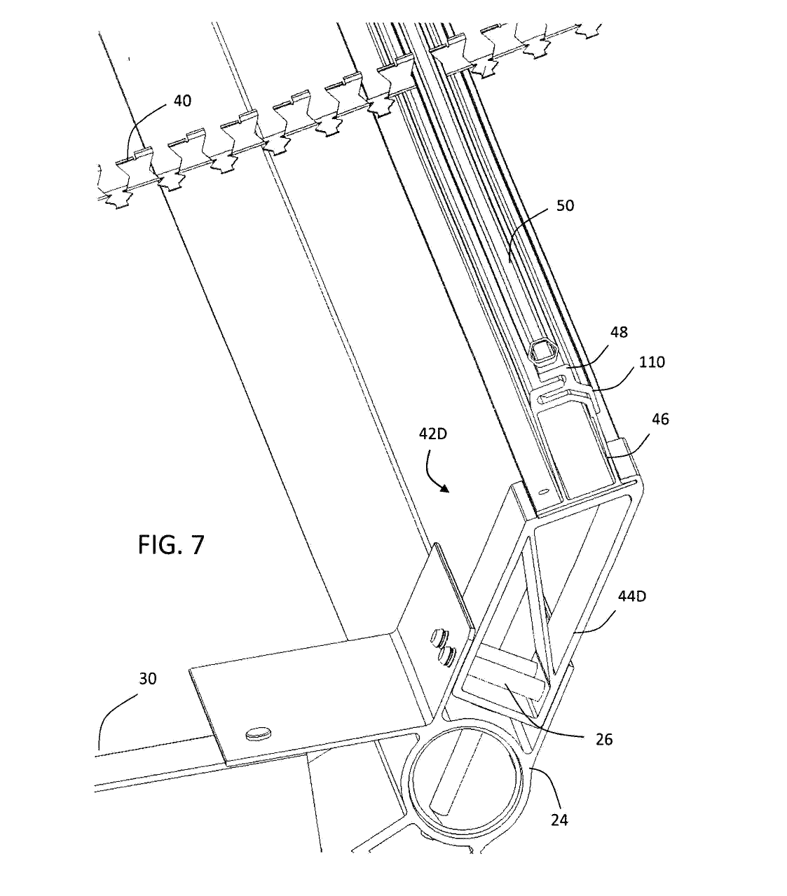

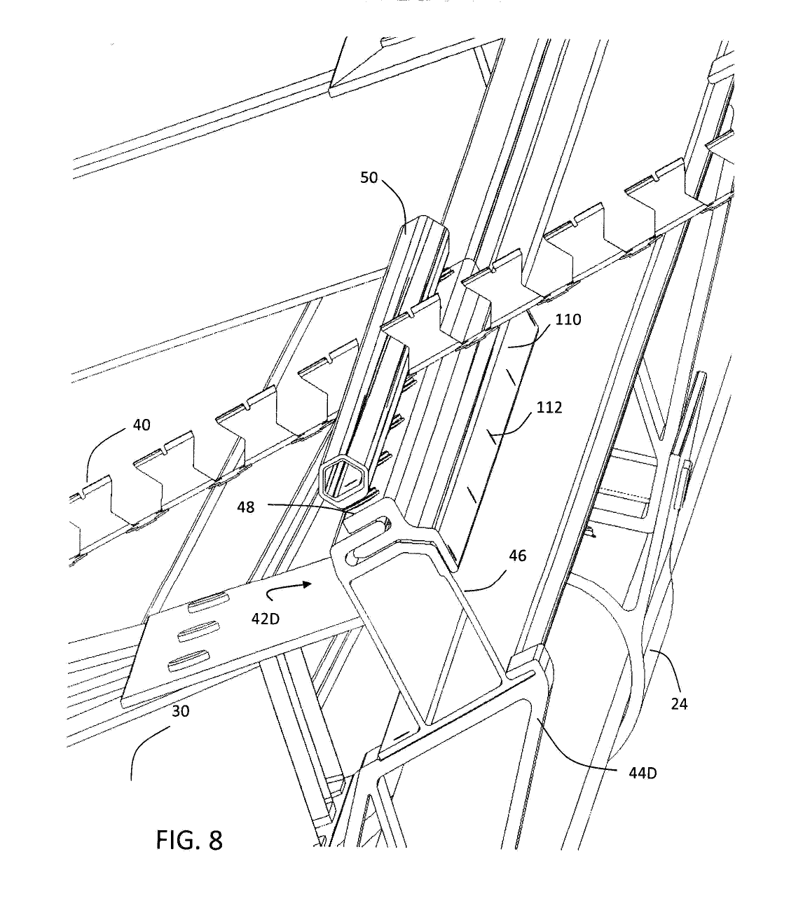

Referring to FIGS. 4-8, the reflector assembly 29 is mounted to the collector side frame members 30 with a plurality of reflector mount assemblies 42A-D. In the following, the reflector mount assemblies 42A-D may be generally referred to with reference number 42. As described in detail below, each reflector mount assembly 42 may include parts that are common to or shared by one or more reflector mount assemblies 42 and parts that may be specific to each reflector mount assembly 42. Each reflector assembly includes a stringer offset 44A-D that is attached to a collector side frame member 30 or a node 24. As shown in FIGS. 7 and 8, the stringer offset 44D is attached to the node 24 as compared to stringer offsets 44A-C, which are attached to the collector side frame members 30. In the following, each of the stringer offsets 44A-D may be generally referred to as a stringer offset 44.

Each reflector assembly also includes a reflector stringer 46 that is attached to a corresponding stringer offset 44A-D, a reflector mount member 48 that is connected to the reflector stringer 46, and a reflector assembly support bar 50 that is attached to the corresponding reflector mount member 48 and to the backing structure 40. Each reflector mount member 48 and the corresponding support bar 50 may be considered to be a first mating portion of a corresponding reflector mount assembly 42. The support bar 50 is exemplary and any type of support structure may be provided instead or in conjunction with the support bar 50. For example, a plate (not shown) may be provided for attachment of the reflector mount member thereto. Alternatively, the first mating portion may be defined by only the reflector mount member 48 when the reflector mount member 48 is directly attached to the backing structure 40 of the reflective assembly 29. The reflector mount member 48 and each support bar 50 may be attached to each other with fasteners, welding or other permanent or removable attachment devices and methods. Each reflector stringer 46 and a corresponding stringer offset 44 may be considered to be a second mating portion of a corresponding reflector mount assembly 42. The reflector stringer 46 and a corresponding stringer offset may be connected to each other permanently such as being manufactured in one piece. Alternatively, as discussed in detail below, each reflector stringer 46 is removably connectable to a corresponding stringer offset 44. The system and methods described herein are not limited in this regard.

As shown in FIG. 1, each reflector stringer 46, each reflector mount member 48 and each reflector support bar 50 extends longitudinally along the frame 20 and serves as a common component to a plurality of reflector mount assemblies 42A-D. Thus, according to the exemplary embodiments described herein, the only part that may be unique to each reflector mount assembly 42 or a longitudinal row of reflector mount assemblies 42 may be the stringer offset 44. However, one of ordinary skill in the art will recognize that some or all of the above-described parts may be unique to each reflector mount assembly 42A-D or common to a plurality of reflector mount assemblies 42A-D as dictated by the design of the frame 20 and the reflector assembly.

As shown in FIGS. 1 and 4-8, each reflector stringer 46 is a continuous beam that extends longitudinally along the collector side 28 of the frame 20. Accordingly, each reflector stringer 46 is connected to a row of stringer offsets 44A, 44B, 44C or 44D that are longitudinally aligned on the collector side 28. The lateral spacing between the reflector stringers 46 may be dictated by the structural support that is required or preferred for the reflector assembly. In the embodiments described herein, each side of the frame 20 has four reflector stringers 46. Thus, four longitudinal rows of stringer offsets 44A-44D are provided for connecting four reflector stringers 46 to the frame 20. In the exemplary embodiments described herein, each reflector stringer 46 is a hollow beam having a rectangular cross-sectional shape. However, the stringers 46 may have any configuration.

Referring to FIGS. 1 and 3, the backing structure 40 has a generally parabolic shape, while the collector side 28 of the frame 20 is formed by planar sections defining a trough for accommodating the parabolic reflector assemblies 29. Because the reflector stringers 46 have the same shape and cross-sectional dimensions, each stringer offset 44 has a predetermined height relative to the collector side 28 of the frame 20 in order to place a corresponding reflector stringer 46 along the same parabolic path as the backing structure 40. As shown in FIG. 3, the parabolic path defining the shape of the backing structure 40 approaches the frame 20 near the stringer offset 44C, while departing from the frame 20 at stringer offsets 44B and 44D. Accordingly, the stringer offset 44C is shorter than the stringer offsets 44B and 44D. The parabolic path defining the shape of the backing structure 40 again approaches the frame 20 at the stringer offset 44A; hence the stringer offset 44A is shorter than the stringer offset 44B.

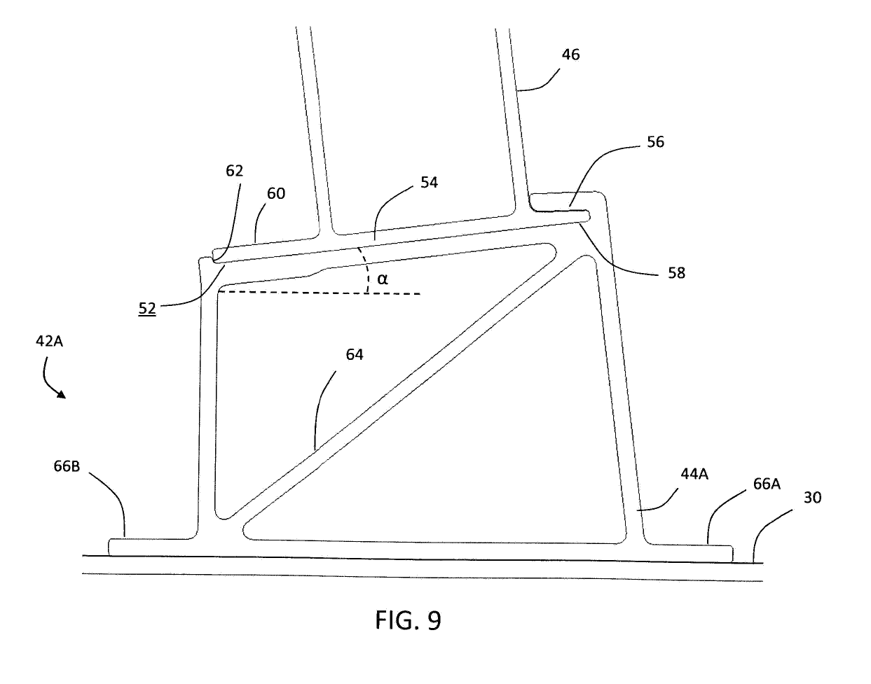

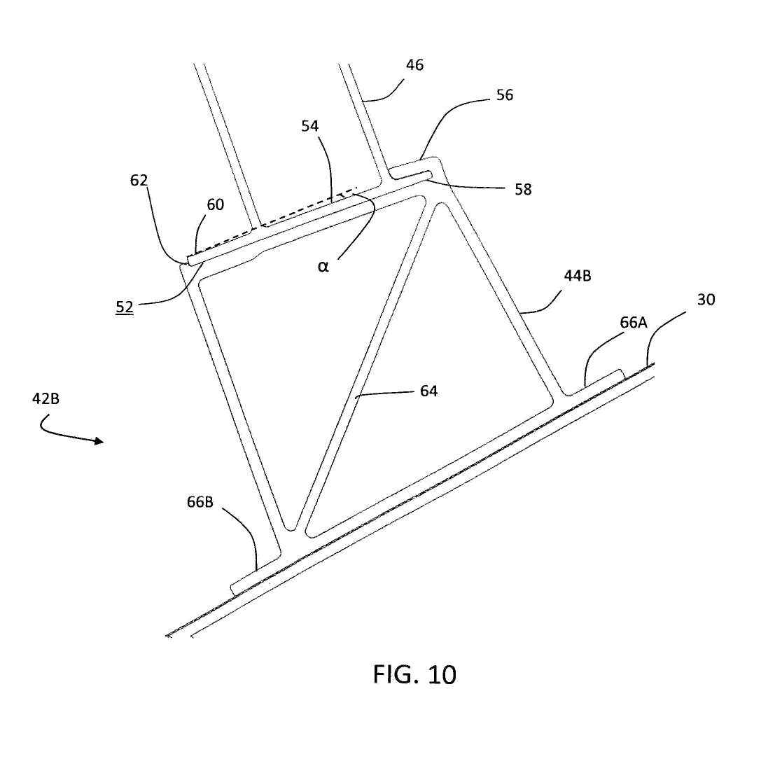

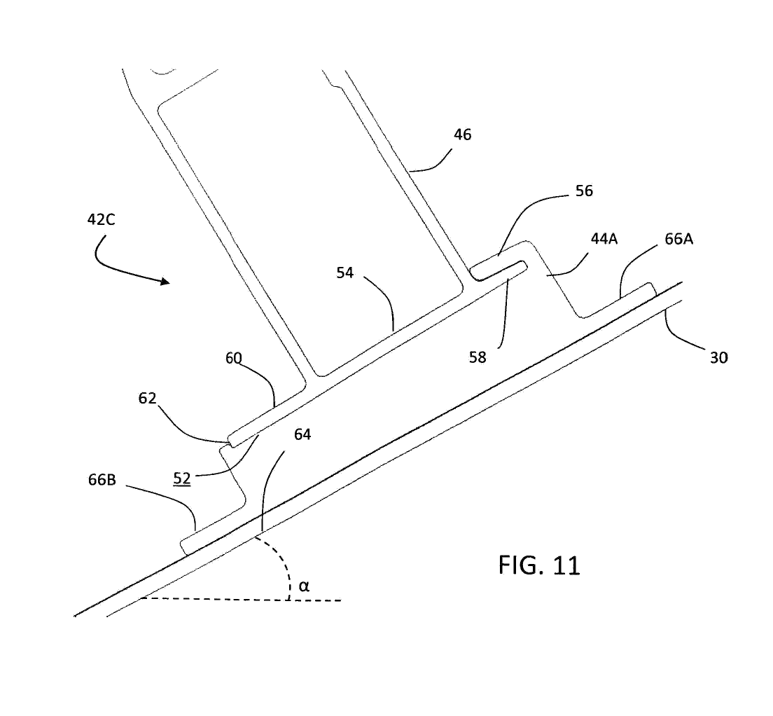

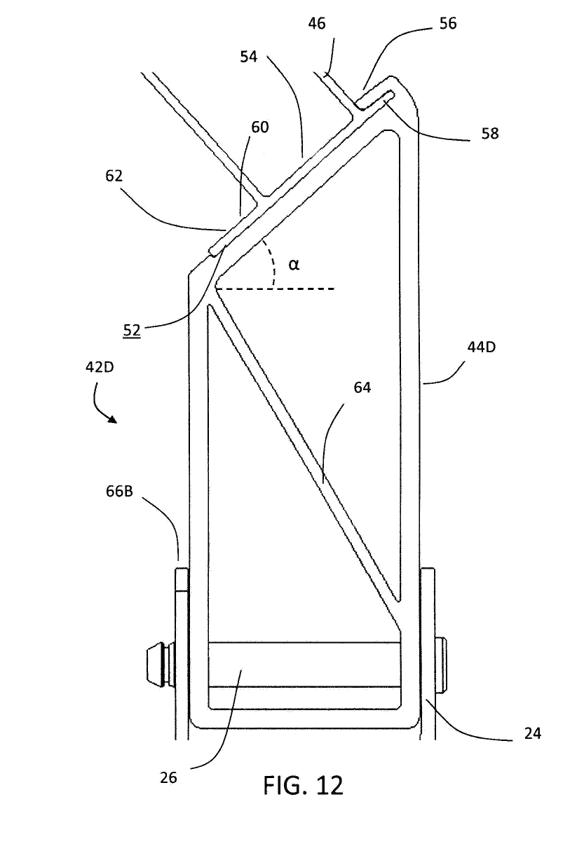

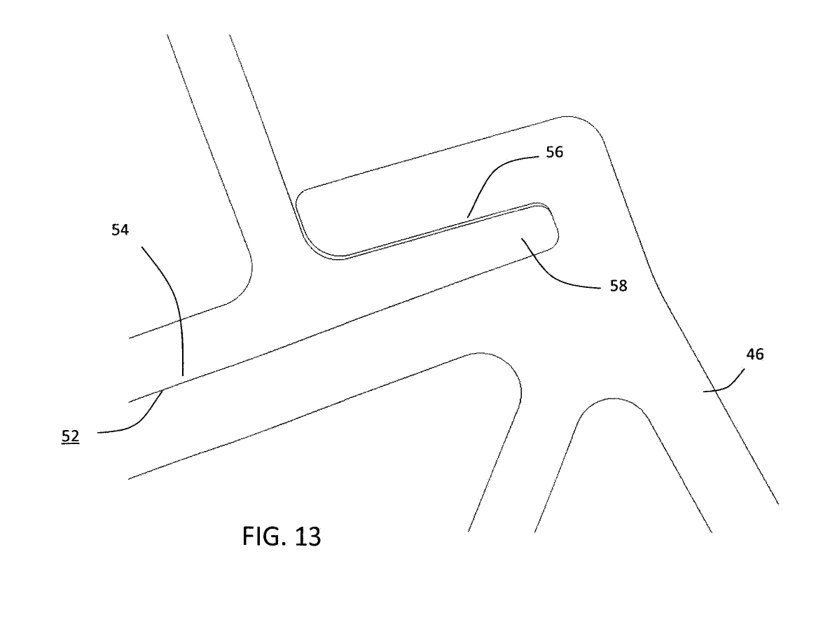

Referring to FIGS. 9-12, each stringer offset 44 has a top portion for receiving a bottom portion of a corresponding reflector stringer 46. The top portion of each stringer offset 44 includes a top plate 52 for receiving a bottom plate 54 of a corresponding reflector stringer 46. The top plate 52 of each stringer offset 44 is oriented at an angle α that is configured to orient the corresponding reflector stringer 46 generally perpendicular to the parabolic path of the reflector assembly and to orient the reflector mount member 48 and/or the support bar 50 generally tangent to the reflector assembly 29 at the point of attachment of the reflector mount member 48 and/or the support bar 50 to the reflector assembly 29. Accordingly, each stringer offset 44 is configured (sized, shaped, manufactured, etc.) to locate and orient relative to the frame 20 a point, surface and/or area of attachment of the reflector mount assemblies 42 to the reflector assembly 29 in all three dimensions so as to properly position the reflector assembly 29 for its intended function (e.g. focusing light onto a certain point, line and/or area). For example, the angle α of the top plate 52 of the stringer offset 44D is greater than the angle α of the top plate 52 of the stringer offset 44C. Referring also to FIG. 13, the top portion of each stringer offset 44 also includes an end channel 56 for receiving a first edge portion 58 of the bottom plate 54 of a corresponding reflector stringer 46. Accordingly, a reflector stringer 46 can be connected to the corresponding stringer offset 44 by first sliding the first edge portion 58 of the bottom plate 54 into the channel 56, followed by fastening a second edge portion 60 of the bottom plate 54 to the top plate 52 with fasteners or other devices and attachment methods. The top portion of each stringer offset 44 may also include a vertical ledge defining a stop 62 that can engage the second edge portion 60 for maintaining a reflector stringer 46 on the top plate 52 before the reflector stringer 46 is fastened to the corresponding stringer offset 44.

As described above, the stringer offsets 44 may have different sizes and shapes depending on their locations on the frame 20. The stringer offsets 44 may be constructed as solid or hollow parts. For example, the stringer offset 44C can be a solid part because it is relatively short. In contrast, the stringer offset 44D is a hollow part because it is relatively tall. Each of the hollow stringer offsets 44A, 44B and 44D can have an internal web 64 for providing structural strength. Furthermore, each stringer offset 44 may have opposing bottom flange portions 66A and 66B for receiving fasteners for attaching the stringer offsets 44 to the collector side frame members 30 with fasteners or other attachment devices and methods.

Referring to FIG. 14, the reflector assembly 29 support bars 50 facilitate connection of the reflector assembly 29 to the reflector stringers 46. Similar to the reflector stringers 46, each reflector support bar 50 is a continuous bar that extends longitudinally along reflector backing structure 40. Accordingly, each reflector support bar 50 corresponds and connects to a corresponding reflector stringer 46 and has the same lateral spacing relative to an adjacent support bar 50 as the lateral spacing of the reflector stringers 46. The reflector backing structure 40 of the exemplary embodiments described herein is in the form of a mini-truss thin sheet panel having hexagonal openings 70 that are longitudinally aligned on the backing structure 40. Each reflector support bar 50 has a hexagonal cross section corresponding in size and shape to the openings 70. Accordingly, each reflector support bar 50 can be inserted and attached to the backing structure 40 by being inserted into a longitudinal row of openings 70. The shape and dimension of the openings 70 and the cross-sectional shape and dimension of the reflector support bars 50 are configured such that the reflector support bars 50 fit inside the openings 70 when inserted in the openings 70. In other embodiments, the reflector support bars 50 may be constructed in one piece or integral with the backing structure 40 such that the step of inserting the support bars 50 in the openings 70 as described above is not required. In other embodiments, the openings 70 of the backing structure 40 and the cross section of the support bars 50 may have any shape other than hexagonal such as square, rectangular, circular, oval, or the like. In other embodiments, the support bars 50 may be defined by sections of the backing structure 40 that are integrally formed with the backing structure as rigid longitudinal sections for mounting the mirror assembly to the reflector stringers 46 as described herein. One of ordinary skill in the art will readily recognize that the backing structure 40 and/or the support bars 50 may have any configuration so as to provide the functions described herein.

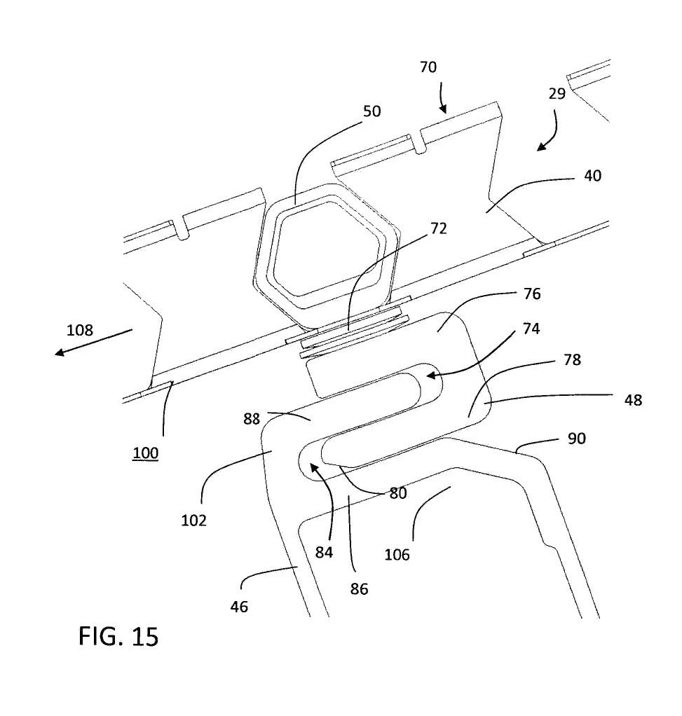

Referring to FIGS. 14 and 15, the reflector mount members 48 are attached to corresponding reflector support bars 50 with fasteners 72. Each reflector mount member 48 defines a U-shaped channel 74 having a pair of side walls 76 and 78. The lower side wall 77 has a tapered or inclined edge portion 80 which assists in assembling the reflector mount member 48 with the corresponding reflector stringer 46 as described in detail below.

A U-Shaped channel 84 is provided on top of each reflector stringer 46 and may extend the length of the reflector stringer 46. The U-shaped channel 84 has a pair of side walls 86 and 88. The side wall 86 extends along the width of the top of the reflector stringer 46 until it meets a tapered or inclined portion 90 on top of the reflector stringer 46. The inclined portion 90 may extend the length of the reflector stringer 46. The channels 74 and 84 are sized and shaped to mate in order to facilitate a connection between the reflector support bar 50 and the reflector stringer 46. As described in detail below, connecting the reflector support bar 50 and the reflector stringer 46 entails inserting the side wall 76 of the reflector mount member 48 into the channel 84 while simultaneously inserting the side wall 78 of the reflector stringer 46 into the channel 74.

When assembling the reflector assembly 29 with the frame 20, the stringer offsets 44 can be first attached to the collector side frame members 30 at the proper locations for receiving the reflector assembly 29 as described above. Accordingly, stringer offsets 44A-44D are attached to the collector side frame members 30 such as to form longitudinal rows of stringer offsets 44A-44D. After attachment of the stringer offsets 44, a reflector stringer 46 is connected to each row of stringer offsets 44A-44D and fastened thereto as described in detail above. In order to facilitate connection of the reflector assembly 29 to the reflector stringers 46, reflector support bars 50 are installed in the backing structure 40 at locations that correspond to the locations of the reflector stringers 46 when the reflector assembly 29 is properly positioned on the collector side 28. When the backing structure 40 includes the mini-truss thin sheet panel having hexagonal openings 70 as discussed above, the reflector support bars 50 are inserted into a row of hexagonal openings 70 along the length of the reflector assembly 29. Prior to or after attaching the reflector support bars 50 to the backing structure 40, the reflector mount members 48 can be attached to the corresponding reflector support bar 50.

Referring to FIGS. 14 and 15, in order to assemble or connect the reflector assembly 29 to the frame 20, the reflector assembly 29 is placed on the collector side 28 of the frame 20 such that the bottom surface 100 of the backing structure 40 rests on the outside surface 102 of the sidewall 88. In this position of the reflector assembly 29, as shown in FIG. 14, the front portion 104 of the inclined surface 80 is located at or near the same vertical level as the front portion 106 of the inclined surface 90. To assemble the reflector assembly 29 with the frame 20, which as described above, entails mating the channels 74 and 84, the reflector assembly 29 is moved in the direction of the arrow 108. Such movement causes the inclined surfaces 80 and 90 to engage, thereby causing inclined surface 80 to slide upward on the inclined surface 90 until the side wall 76 is positioned at the mouth of the channel 84 and the side wall 88 is positioned at the mouth of the channel 74. The reflector assembly 29 can then be moved slightly farther along in the direction of the arrow 108 until the channels 74 and 76 fully mate. The reflector assembly 29 is now fully connected to the frame 20.

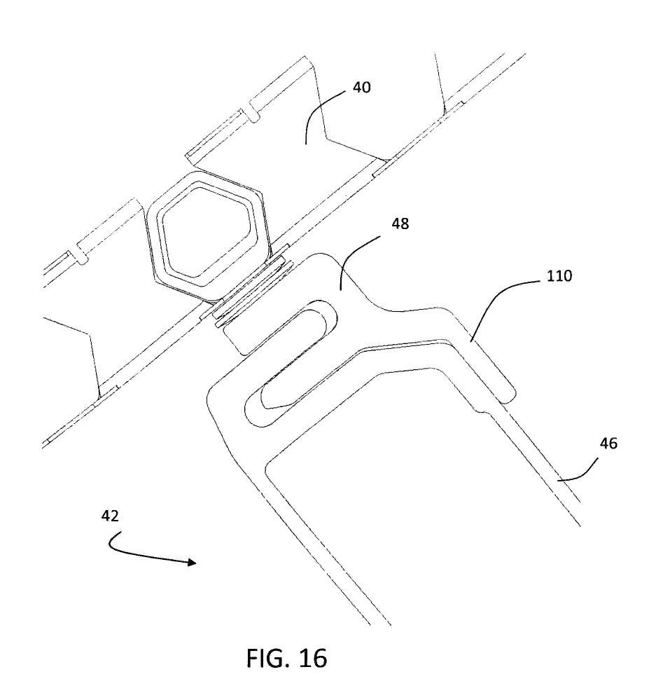

Referring to FIGS. 7, 8 and 16, in order to prevent the reflector assembly 29 from becoming disconnected from the frame 20 due to external forces or other factors, the reflector assembly 29 is securely connected to the frame 20 by fastening the last or outermost reflector mount member 48 to its reflector stringer 46. The last reflector mount member 48 includes a downwardly extending wall 110 that engages the corresponding reflector stringer 46 to function as a stop when the reflector assembly 29 is fully assembled to the frame 20. The wall 110 can be fastened to the reflector stringer 46 by any type of fastener or other devices and methods. For example, FIG. 8 shows the wall 110 to include a plurality of bores 112 for receiving bolts or screws to fasten the reflector mount member 48 to the reflector stringer 46. Because the inner reflector mount members 48 may be difficult to reach by an operator after assembly, providing fastening mechanisms on the last or outermost reflector mount members 48 allows an operator to easily reach these reflector mount members 48 for fastening the reflector assembly 29 to the frame. Furthermore, the focusing sensitivity of the parabolic reflector panel is greater on the outer portions of the reflective panel than the center portions. Accordingly, by providing the wall 110, which also functions as a stop, on the last or outermost reflector members 48 provides for accurate positioning of the outer portions of the reflective panel relative to the frame.

The components of the reflector mount assemblies on the frame side, namely the stringer offsets 44 and the reflector stringers 46 can be assembled to the frame either at the operation site or prior to transporting the frame to the operation site. Similarly, the components of the reflector mount assemblies on the reflector side, namely the reflector support bar 50 and the reflector mount member 48 can be assembled to the reflector mount assembly either at the operation site or prior to transporting the reflector mount assembly to the operation site. At the operation site, at least two persons are required to connect the reflector mount assembly to the frame 20. Each person can stand on opposing longitudinal ends of the frame 20 in order to lift the reflector assembly 29 over the collector side 28 and place the reflector assembly 29 on the reflector stringers 46 as described above. The reflector assembly 29 is placed on the reflector stringers 46 such that each reflector mount member 48 is generally at the position shown in FIG. 14 relative to its corresponding stringer 46. In other words, the reflector assembly 29 is placed by these persons such that the channels 74 and 84 face each other and the front portion 104 of the inclined surface 80 and the front portion 106 of the inclined surface 90 are facing each other. The two persons then simultaneously push the reflector assembly 29 in the direction of the arrow 108 until the channels 74 and 84 have fully mated, i.e., the reflector assembly 29 may no longer be movable in the direction of the arrow 108 due to the wall 110 engaging its corresponding reflector stringer 46. Then, one or both of the persons can fasten the last reflector mount member 48 the corresponding stringer 46 as described above. The above assembly process can be repeated for each reflector assembly 29 of a solar power generation plant.

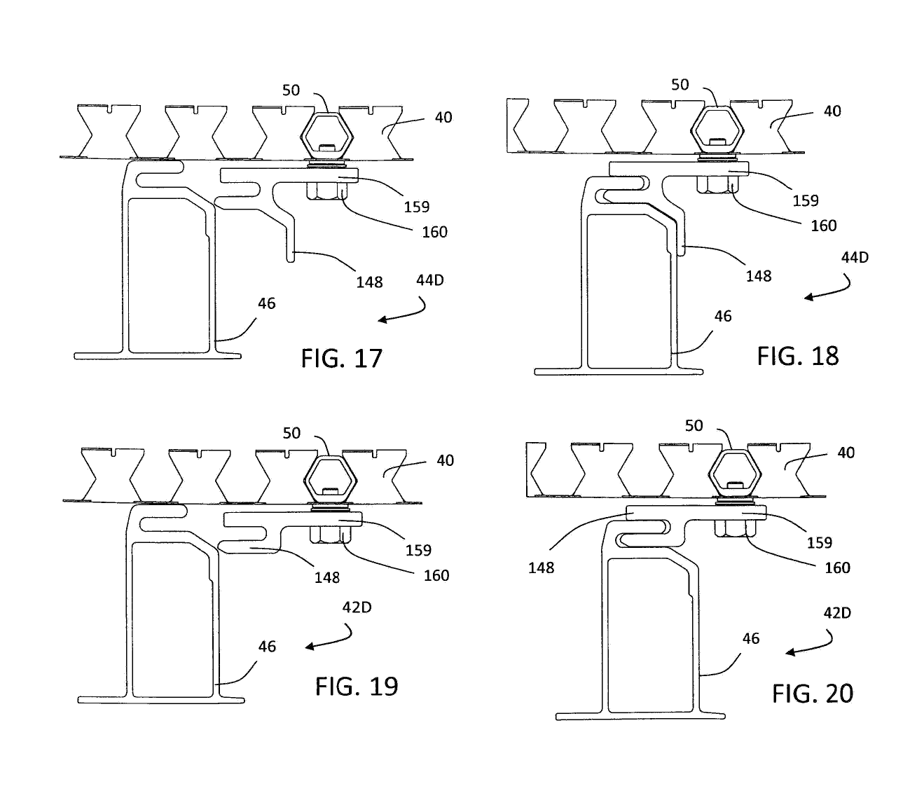

Referring to FIGS. 17-20, a reflector mount member 148 according to another embodiment is shown. The reflector mount member 148 includes a tab 159 that extends opposite to the U-shaped channel 74 to provide a mounting platform for attachment of the support bar 50. As shown in FIGS. 17-20, the support bar 50 may be attached to the tab 150 with a bolt 160 or other types of fasteners. According to the embodiment of FIGS. 17-20, the bolt is outside the channel 74 and does not occupy any space inside the channel 74. Therefore, any size and configuration for the bolt may be used.

Although the above description relates to a solar power generation system, the systems and methods described herein may be used in any application where a curved panel is to be mounted to a frame. Such applications may be for example in construction of commercial and residential buildings, bridges, towers, architectural panels for attachment to exterior or interior of a building. Thus, the system and methods described herein are not limited in this regard.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A system for mounting a curved panel to a frame, the system comprising:
a plurality of first mating assemblies, each first mating assembly having a first side defining a first mating portion and a second side configured to attach to the curved panel and being spaced apart from an adjacent first mating assembly along a curvature of the panel when attached to the curved panel;
a plurality of second mating assemblies, each second mating assembly having a first side defining a second mating portion and a second side configured to attach to the frame and being spaced apart from an adjacent second mating assembly along the frame when the second mating assembly is attached to the frame, each of the second mating portions configured to removably mate with one of the first mating portions to connect the plurality of first mating assemblies to the plurality of second mating assemblies; and
wherein the second mating portion of each of the second mating assemblies is configured generally along the curvature of the panel relative to the second mating portion of an adjacent second mating assembly.

2. The system of claim 1, wherein the first mating portion is a generally U-shaped channel, wherein the second mating portion is a generally U-shaped channel, and wherein when the first mating portion is mated with the second portion, a portion of the U-shaped channel of the first mating portion is located inside the U-shaped channel of the second mating portion and a portion of the U-shaped channel of the second mating portion is located inside the U-shaped channel of the first mating portion.

3. The system of claim 1, wherein each of the second mating assemblies comprises an offset section configured to attach to the frame and the second mating portion attached to the offset section, wherein the offset section is configured to provide an offset distance for the second mating portion relative to the frame such that the second mating portion is positioned generally along the curvature of the panel relative to the second mating portion of an adjacent second mating assembly.

4. The system of claim 3, wherein the offset section comprises a longitudinally extending slot configured to receive a longitudinally extending flange of the second mating portion.

5. The system of claim 1, wherein the curvature of the panel is defined along a width of the panel, and wherein each of the first mating assemblies and the second mating assemblies generally extend along the length of the curved panel and are spaced apart along the width of the curved panel.

6. The system of claim 1, wherein each of the first mating assemblies comprises a longitudinal member extending along a length of the curved panel when the first mating assembly is attached to the curved panel, and wherein the first mating portion is attached to the longitudinal member.

7. The system of claim 1, wherein at least one of the first mating assemblies is fixedly attached to a corresponding second mating assembly.

8. The system of claim 1, wherein the first mating portion comprises a guide portion configured to guide the second mating portion into mating connection with the first mating portion.

9. The system of claim 1, wherein the second mating portion comprises a guide portion configured to guide the first mating portion into mating connection with the second mating portion.

10. A method of mounting a curved panel to a frame, the method comprising:
attaching a plurality of first mating assemblies to the curved panel such that each of the first mating assemblies is spaced apart from an adjacent first mating assembly along a curvature of the panel, each first mating assembly having a first side defining a first mating portion and a second side configured to attach to the curved panel;
attaching a plurality of second mating assemblies to the frame such that each of the second mating assemblies is spaced apart from an adjacent second mating assembly along the frame, each second mating assembly having a first side defining a second mating portion and a second side configured to attach to the frame, and the second mating portion of each of the second mating assemblies configured generally along the curvature of the panel relative to the second mating portion of an adjacent second mating assembly; and
removably mating each of the first mating portions with one of the second mating portions to connect each of the first mating assemblies to a corresponding one of the second mating assemblies.

11. The method of claim 10, wherein removably mating each of the first mating portions with one of the second mating portions comprises inserting a portion of the U-shaped channel of the first mating portion inside the U-shaped channel of the second mating portion, and inserting a portion of a U-shaped channel of the second mating portion inside the U-shaped channel of the first mating portion.

12. The method of claim 10, wherein attaching a plurality of second mating assemblies to the frame comprises attaching an offset section of each of the second mating assemblies to the frame and attaching the second mating portion to the offset section, wherein each offset section is configured to provide an offset distance for the second mating portion relative to the frame such that the second mating portion is positioned generally along the curvature of the panel relative to the second mating portion of an adjacent second mating assembly.

13. The method of claim 12, wherein attaching the second mating portion to the offset section comprises inserting a longitudinally extending flange of the second mating portion into a longitudinally extending slot of the offset section.

14. The method of claim 10, wherein the curvature of the panel is defined along a width of the panel, and wherein each of the first mating assemblies and the second mating assemblies generally extend along the length of the curved panel and are spaced apart along the width of the curved panel.

15. The method of claim 10, wherein each of the first mating assemblies comprises a longitudinal member extending along a length of the curved panel, and wherein the first mating portion is attached to the longitudinal member.

16. The method of claim 10, further comprising fixedly attaching at least one of the first mating assemblies to a corresponding second mating assembly.

17. The method of claim 10, wherein removably mating each of the first mating portions with one of the second mating portions comprises guiding the second mating portion into mating connection with the first mating portion with a guide portion of the first mating section.

18. The method of claim 10, wherein removably mating each of the first mating portions with one of the second mating portions comprises guiding the first mating portion into mating connection with the second mating portion with a guide portion of the second mating section.

19. A system for mounting a curved panel to a frame, the system comprising:
a plurality of first mating assemblies configured to attach to the curved panel, each of the first mating assemblies being spaced apart from an adjacent mating assembly along a curvature of the panel when the first mating assemblies are attached to the curved panel, each of the first mating assemblies comprising:
a longitudinal member extending along a length of the curved panel when the first mating assembly is attached to the curved panel; and
a generally U-shaped first channel attached to the longitudinal member.
a plurality of second mating assemblies configured to attach to the frame, each of the second mating assemblies comprising:
an offset section configured to attach to the frame in a spaced apart configuration relative to the offset section of an adjacent second mating assembly;
a generally U-shaped second channel attached to the offset section; and
wherein the offset section is configured to provide an offset distance for the generally U-shaped second channel relative to the frame such that the generally U-shaped second channel is positioned generally along the curvature of the panel relative to generally U-shaped second channel of an adjacent second mating assembly; and
wherein a portion of the generally U-shaped first channel is located inside the generally U-shaped second channel and a portion of the generally U-shaped second channel is located inside the generally U-shaped first channel when the first mating assembly and the second mating assembly are removable connected.

20. The system of claim 19, wherein the offset section comprises a longitudinally extending slot configured to receive a longitudinally extending flange coupled to the of the generally U-shaped second channel.

21. The system of claim 19, wherein the curvature of the panel is defined along a width of the panel, and wherein each of the first mating assemblies and the second mating assemblies generally extend along the length of the curved panel and are spaced apart along the width of the curved panel.

22. The system of claim 19, wherein at least one of the first mating assemblies is fixedly attached to a corresponding second mating assembly.

23. The system of claim 19, wherein the generally U-shaped first channel comprises a ramp portion configured to guide the generally U-shaped second channel into mating connection with the generally U-shaped first channel.

24. The system of claim 19, wherein the generally U-shaped second channel comprises a guide portion configured to guide the generally U-shaped first channel into mating connection with the generally U-shaped second channel.
